(19) United States
(12) Patent Application Publication
(10) Pub. No.: US 2006/0062691 A1
(43) Pub. Date: Mar. 23, 2006

(54) Electronic flow control system for gas phase dilution

(76) Inventors: Noel C. Bauman, College Station, TX (US); Gary Erickson, College Station, TX (US); Richard K. Simon JR., College Station, TX (US); Karl M. Williams, Bryan, TX (US)

Correspondence Address: ROBERT L. GREESON;7th Floor, 900 Washington Avenue, P.O. Box 1470, Waco, TX, 77603-1470, US

(21) Appl. No.: 10/946,896

(22) Filed: Sep. 22, 2004

(51) Int. Cl. G01D 21/00

(52) U.S. Cl. 422/62; 422/98

(57) ABSTRACT

An electronically controlled gas flow dilution system. This dilution system is configured to allow dynamic, real-time dilution of a sample gas before said gas flows through a detector. A flow sensor measures total gas flow from both an independent source (of diluent gas) and gas flowing from a standard combustion system. Said flow sensor, in conjunction with other system components, allows the system operator to evaluate and manipulate concentration of the sample gas as it passes through a detector. Finally, this system provides for a range and accuracy of detection, with respect to sample concentration, simply not possible with available systems.

### BACKGROUND OF THE INVENTION

1. Field of The Invention

The present invention generally relates to improved analytical detection of chemical compounds in the gas phase. More specifically, the present invention relates to improved detection of carbon dioxide, produced from oxidative reactions, generally utilizing a concentration dependent non dispersive infrared detector (NDIR) within a Total Organic Carbon Analyzer (TOC).

2. Background Information

Current total organic carbon (TOC) analyzer systems generally utilize one or more basic oxidation processes, including: high temperature oxidation (or combustion), reaction of organic species by persulfate and acid (heated or non-heated), photo-catalytic oxidation, and electrochemical oxidation.

In general, an analytical sample is quantitatively transferred to a TOC analyzer, is oxidized, and after oxidation, is swept by a gas out of the oxidation region, through a bulk drying area, then through a dehydration region, and finally into a detector (e.g. a Non Dispersive Infrared Detector, NDIR). The detector is optimized for the detection of carbon dioxide. For optimal performance, the detector requires removal of water vapor (to as low a vapor pressure as possible) from the transport stream prior to detection.

Elimination of water vapor from within the NDIR detection chamber is of the utmost importance as water and carbon dioxide share regions of absorption in the infrared region. The presence of water produces noise and quantization errors. Secondary effects of water passing through the detector include degradation of the optical path, windows, and sensor. These secondary effects are primarily due to other reactive gases eluting from the reaction chamber. These reactive gases, together with water vapor, can result in acidic condensates on the interior surfaces of the NDIR flow path, which can degrade the surfaces, cause instability, noise, and potential variable sensitivity (i.e. low reproducibility or precision).

### State of the Prior Art

Total Organic Carbon Analyzer systems, as known in the art, are limited in view of the present invention. Specifically, known TOC systems are unable to effectively, simultaneously analyze a broad range of samples. Such constraint is due to the limited dynamic range of the non dispersive infrared detector (NDIR) for a specific oxidation process. The dynamic range of the NDIR detector is reached, at the lower limit when system “noise” becomes a significant portion of the NDIR measurement, and is reached at the upper limit when the detector becomes saturated, or the sensitivity (slope of the response versus concentration of the analyte) of the NDIR detector approaches zero.

The uncertainty in the measurement of an analyte increases as the concentration passing through the detector increases. The ultimate limitation arises when detector “noise” corresponds to a significant fraction of the linearized response. In this region of detector response, a small change in signal corresponds to a large uncertainty in concentration. The upper limitation on sample quantization occurs when the uncertainty in the integration of the linearized response (in the case of quantization of analyte by peak area) increases above an analyst's limitation for uncertainty in quantization of replicate (aliquot) samples. In a similar manner, a lower limit is established by uncertainty corresponding to the limitations of quantization at low concentrations (with noise again being the limiting factor).

With currently known systems, as the NDIR is adjusted to optimize sensitivity and detection limits, a trade off is required which lowers quantization of high level carbon samples. Alternatively, as the sample path length is decreased to permit quantization of high level carbon samples; a trade off is required as there is a decreased ability to quantitate a sample with low levels of carbon. In general, TOC designs using long sample path lengths (for optimal detection of carbon at low levels) are utilized. Further, the limitation on quantization of high level samples results in the system operator (“analyst”) being required to further dilute the analyte.

Systems known in the art have developed common techniques to expand the NDIR detection range with respect to analyte concentration, albeit with limited success. These techniques include: varying the aliquot size, increasing the transport gas through the oxidation chamber, changing the detector cell path length, or the use of multiple detectors (one tuned for high concentration, and a second detector tuned for high sensitivity). However, none of these attempted solutions begin to reach the benefits provided by the current system. Uneliminated problems associated with such techniques include: (1) degradation in accuracy and sample quality, (2) an increase in water vapor within the system, (3) multiple detector calibrations, (4) redundant sources, detectors, and associated electronics, and (5) additional complexity in gas connections to the detector.

The use of a smaller or larger aliquot size (i.e. smaller or larger loop size) has been often employed in an attempt to alleviate some of the problems associated with current TOC systems. However, such process is only of limited value, as the relative accuracy for comparing the various aliquot sizes is rapidly degraded. This dilemma is due to different amounts of reagents required to match aliquot volume and the often ignored carbon contribution due to reagent preparation or reagent carbon purity issues. Moreover, accurate low-level measurements are further hindered, as the contribution of carbon at low levels has been an unavoidable problem—due to the ubiquitous nature of carbon in water, acids, and even highly scrubbed air.

Commonly, TOC systems achieve dilution of the analyte by increasing the purge or transport gas through the oxidation chamber. However, dilution performed in this manner is often unsatisfactory, as this also transports additional water vapor to both dehydration elements. The higher amounts of water vapor and higher flow rates place severe constraints on the size and drying efficiency of the various dehydration methods, such as Peltier cooling of surfaces, Nafion tube driers, or chemical sorbents.

By virtue of a novel electronically controlled gas flow mechanism, the present system facilitates dilution of oxidation products prior to detection. Such dilution is performed using “dry gas” so that virtually no water vapor is added to the system. Importantly, this “dry gas” is not pushed through the reaction chamber, but is introduced into the system from an adjacent, independent source. As such, additional water vapor does not reach the detection chamber, and dehydration efficiency is not only preserved, but in most cases the amount of water vapor reaching the detector is actually even further reduced.

Operation of the system is extremely flexible as the system operator is able to manipulate dilution levels according to operator-defined limits. In the event the concentration is outside of established, user-defined limits, the diluent gas flow may be quickly readjusted (increased or decreased) so as to optimize accuracy and precision of analyte analysis in real-time. Summarily, the electronic flow control mechanism of Applicant's system allows the analyst to extend the upper dynamic range of the TOC system while maintaining optimal performance, reduce water vapor reaching the detector, and eliminate the need for further dilution of high-level samples.

The attributes of applicant's invention lend themselves to either manual or unattended, automated system operation. Traditionally, these methods have been problematic due to the additional uncertainty resulting from errors in subsequent dilution steps and potential contamination of the sample by trace levels of carbon in the dilution media. During unattended automated runs, the sample itself is often consumed in the measurement process. In a like manner, the sample can be exposed to atmospheric carbon dioxide once the septum is punctured during sampling.

Applicant's invention presents effective solutions to the most common and serious limitations associated with currently available TOC analyzer systems. The present system can analyze high-level samples with optimized sensitivity and detection limits, and can maintain such optimal performance during the measurement of low-level samples. Through a novel combination of system components and processes, the present system facilitates dilution of oxidation products before detection. As a result, the analyst is able to extend the upper dynamic range of the TOC system. Moreover, the present system provides an effective means whereby samples may be effectively analyzed in an automated or manual fashion. Extension of the dynamic range to higher concentration samples eliminates the requirement of sample dilution prior to detection analysis, and, problems such as sample contamination and dilution process errors are eliminated. Consequently, efficiency with respect to man-power, resource preservation, and operation costs are greatly increased.

### SUMMARY OF THE INVENTION

In view of the foregoing, it is an object of the present invention to provide a gas dilution system whereby the sample may be diluted before entering the detection chamber.

It is another object of the present invention to provide a gas dilution system where the dynamic detection range of the system is increased with respect to high concentration and low concentration samples.

It is another object of the present invention to provide a gas dilution system where its operator may define acceptable upper and lower concentration limits.

It is another object of the present invention to provide a gas dilution system where its operator may adjust diluent gas flow, and therefore analyte concentration, in real time.

It is another object of the present invention to provide a gas dilution system where the amount of water vapor in the detection chamber is greatly reduced.

It is another object of he present invention to provide a gas dilution system that increases operating efficiency with respect to costs, required man power, and sample conservation.

In satisfaction of these and other related objectives, Applicant's invention provides a system whereby the flow of diluent gas is electronically controlled as it sweeps an analyte gas through a detector. This electronic flow control establishes a number of attributes that were previously not available with TOC systems. Importantly, the present system operates independently of, and is equally beneficial to, any number of oxidation reactions. As such, the present system may be used in conjunction with any number of oxidation reactions, including: high temperature oxidative combustion, wet oxidation methods, photo-catalytic reactions, and “reagent-less” electrochemical oxidation.

General operation of TOC systems involves quantitative transfer (either by mass or by volume) of an aliquot of sample into a reaction chamber. This transfer can be performed manually (i.e., using a syringe), or through use of an automated system, such as gas transport, a syringe pump, or another transfer means as known in the art. Reagents are then added to the reaction chamber to initiate oxidation of the sample. The reagent of choice primarily depends on the oxidation mechanism. After the oxidative reaction occurs, the analyte is swept through a bulk drying area, a dehydration area, and then into the detection chamber. The present invention is positioned so as to manipulate the concentration of analyte gas as it flows from the dehydration stage to the detection stage. Concentration adjustments are made based on comparisons between a user defined acceptable concentration amount, and readings obtained from instruments of the present system. Further, these adjustments can be made on a real-time basis.

By way of practical application, if the analyzed sample concentration is below a user-defined set point, the electronic flow control (“EFC”) module can adjust the total flow at a low level (minimum dilution). If the sample is within an optimal range, the EFC module can be adjusted to an intermediate flow rate. If the sample concentration is above a user defined set point, the EFC module gas flow can be increased for additional dilution. For example, the lower limit may be set to 1 ppm carbon, and the lower flow rate set to 50 ml/min total flow. The normal range may be from 1 ppm to 1000 ppm carbon for a “conventional” flow rate of 100 ml/min. The upper limit corresponding to analyte concentrations greater than 1000 ppm carbon may set the total flow to 1000 ml/min for maximum dilution. Taken together, these adjustments of total flow rate to the NDIR can result in extension of the dynamic range (with improved precision of quantitation) from between four orders of magnitude, to six orders of magnitude.

Operation of the Electronic Flow Control system commences as the mass flow sensor generates a signal, corresponding to total flow through the sensor. The signal produced corresponds to the sum of flow produced from the sample gas (analyte) as it comes from the combustion system, and the carrier gas as it flows from the electronic flow control (EFC) module.

The signal generated by the flow sensor is then selected by a multiplexer, and sent to an analog to digital converter (ADC). The output from the ADC is then read by a PIC micro-controller. The ADC reading is then compared with a computed user-defined set point. This user-defined set point is introduced to the system at a user interface and can be continuously adjusted in real time. This feature alone sets the present invention apart from systems known in the art.

The PIC micro-controller utilizes a PID algorithm to generate an output waveform. Said output waveform is sent, as output, to a VSO valve. The VSO valve is thereby controlled by the waveform, produced by the PID algorithm, and received from the PIC micro-controller. Ultimately, actuation of the VSO valve determines how much carrier gas flows through the EFC module.

The output waveform consists of a pulse width modulated signal (with 12 bits of resolution) whose width of modulation is set by the PID algorithm. The output of the mass flow sensor is calibrated using either a fifth order polynomial, of the form:
ADC_setpoint=((((a*flow_setpoint+b)*
flow_setpoint+c)*
flow₁₃ setpoint+d)*
flow_setpoint+e)*
flow_setpoint+f),
or as a rational polynomial of the form:
ADC_setpoint=(a+b*flow_setpoint)/(1.0+c*flow_setpoint).

where flow_setpoint corresponds to the flow rate set by the user

The error term for the PID algorithm then simply becomes the difference between the ADC_setpoint and the measured ADC value. The flow_setpoint variable in the above equations corresponds to the flow rate set by the user.

A differential form of the PID algorithm can be used with limits on the acceptable PID results of 0.00 (for the minimum PID value) and 1023.0 (for the maximum PID value), preventing problems with system ‘wind-up’ when transitioning from high to low or low to high values. Empirical optimization of the system results in the PID coefficients being determined in an iterative manner for minimum oscillations and maximum responsiveness to any change in the TOC system.

For minimal error, the fifth order polynomial is optimal (as referenced above), but requires regression techniques for proper fitting of the mass flow sensor response to flow. Using the regression technique with proper weighting of each point set, the flow accuracy can be within a 1% band from 10 mL/min to 1000 mL/min (based on 30 measurements logarithmically distributed from 1.0 mL/min to 1000 mL/min, i.e. 10 point per decade).

For greatest ease of use, the rational polynomial only requires three measurements and can be analytically fit to a set of equations, which generate the coefficients. Using the rational polynomial results in the flow accuracy being with a 3% band from 10 mL/min to 1000 mL/min (based on flow measurements at or near 10 mL/min, 100 mL/min, and 700 mL/min).

The reproducibility of the electronic flow controller is the same, regardless of the method of calibration and computation of the error term. The optimal approach is the rational polynomial form, since the TOC system is calibrated for each flow setting selected. The additional effort required for both measurements of the flow and signal (ADC) values, and subsequent computation of the higher order polynomial is unwarranted.

As a practical matter, fluid flow through the EFC module is a simple tee arrangement where the sample gas, having traveled through the reaction system (containing the relatively dry, carbon dioxide analyte), combines with the output from the VSO—frit assembly. The combined flow then vents into the inlet of the flow sensor. The outlet of the mass flow sensor is then coupled to the NDIR. Finally, the outlet from the NDIR can be directed to vent or to other detectors.

Implementation of the EFC module facilitates rapid set-up and purging of the NDIR detector. This action provides for rapid re-establishment of the NDIR response to samples with very low concentrations of carbon dioxide. Since the NDIR has significant volume, operationally the elution profile (often referred to as a peak) can show “tailing” due to a volumetric time constant effect. The detector response return to baseline for a specific fraction of the peak height (e.g. 95%) is rapid; but the tailing (when magnified for low level sensitivity) will appear as a significant offset and/or drifting baseline. This problem is fixed by setting the EFC to a high flow rate (momentarily)—this will rapidly aid in vacating the NDIR of the remaining traces of carbon dioxide, down to levels amenable to trace level quantitation in subsequent analyses. The use of the “95% return to baseline” permits analysis termination without uncompensated error, since the tailing is essentially an exponential decay. As the tailing component of detector response falls below standard noise level, (which is accounted for), for all practical purposes, the detector is said to have returned to baseline. At such point, the detector is again ready for low concentration samples. With systems known in the prior art, this feature or anything analogous to it, is simply not available.

Since calibration curves are generated using the “return to baseline” criteria for stop of peak integration, high precision and accuracy are ensured for unknown analytes that are treated in the same manner. The advantage is a decrease in analysis time, greater accuracy in determination of the end of peak integration, and a reproducible starting level for both the calibration standards and the unknown samples.

For example, where the same analyte was analyzed at two different total flow rates, i.e. nominally 70 mL/min and 700 mL/min, a decrease in peak height for the higher flow rate was observed. As stated above, the higher flow rate results in moving the maximum analyte concentration to a higher concentration without the requirement of changing the detector geometry or upstream sample size. This ability to dynamically change the limits of quantitation without changing the system mechanically and without additional dilutions of the analyte makes the TOC system more robust, as well as easier to use by the analyst.

As an added benefit, employment of the present system provides the operator with the ability to dilute, or otherwise modify the system geometry, for optimal performance of the TOC system. Therefore, the TOC system can operate with a ‘standard’ configuration if it is so desired. The EFC contribution permits analysis for those samples that fall “outside” the normal bounds for quantitation.

The EFC module can be utilized in systems having more than one oxidative reactor. In these systems, the EFC can match total flow without the requirement of additional tuning, to match flows through the reactor, and dehydrating regions. For systems that use stopped flow techniques (i.e. no transport gas being passed through the reactor, with the sample decomposition product of carbon dioxide either being trapped in the reactor, or being allowed to expand into the dehydration stages, or combination of both), when the flow is resumed during the ‘detect’ phase of the analysis (e.g. sample phase, add reagent phase, react phase, transport and detect phase) the flow can be rapidly brought up to a controlled flow rate at the NDIR. This permits precise quantitation without the problems of the flow not being at the desired flow rate prior to analyte detection.

### BRIEF DESCRIPTION OF THE DRAWINGS

Applicant's invention may be further understood from a description of the accompanying drawings, wherein unless otherwise specified, like referenced numerals are intended to depict like components in the various views.

FIG. 1 is a schematic diagram of a TOC Analyzer (wet chemical type) incorporating the EFC (electronic flow control module) according to the present invention.

FIG. 2 is a schematic diagram of a TOC Analyzer (combustion type) incorporating the EFC (electronic flow control module) according to the present invention.

FIG. 3 is a schematic diagram of the EFC (electronic flow control module) according to the preferred embodiment of the present invention.

FIG. 4 is a schematic diagram of the EFC (electronic flow control module) according to an alternative embodiment of the present invention with splitting of the sample prior to the detector (maintaining constant flow through the detector).

FIG. 5 is a schematic diagram of the EFC (electronic flow control module) according to an alternative embodiment of the present invention utilizing frits for discrete levels of generating the diluent flow.

### DETAILED DESCRIPTION OF THE PREFERRED EMBODIMENT

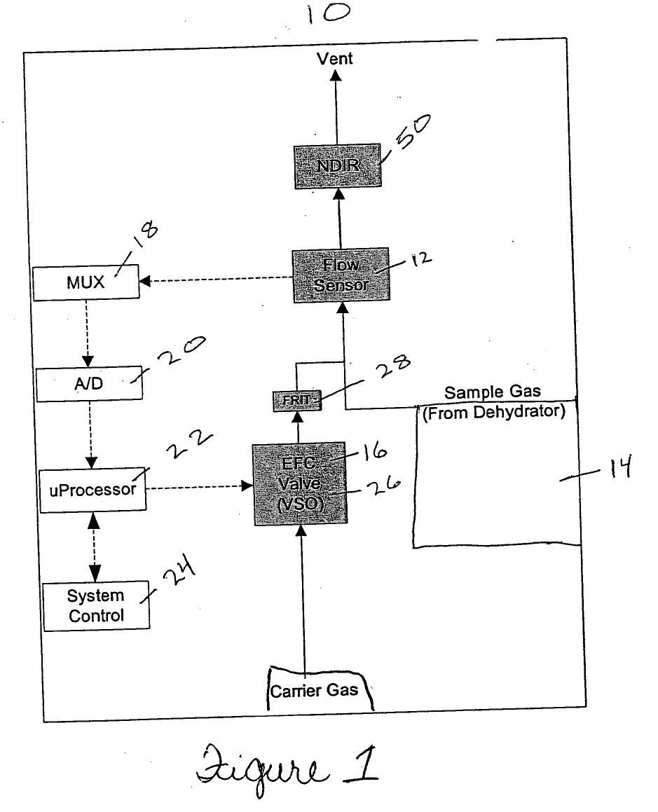

Referring to FIG. 1, the system of the present invention is generally referred to by the numeral 10. System 10, in its most preferred form, can be used in conjunction with any carbon-oxidation reaction system as known in the art. As such, system 10 is applied with equal benefit to high temperature oxidative combustion, wet oxidation methods, photo-catalytic reactions, and “reagent-less” electrochemical oxidation. Operation of system 10 is initiated as mass flow sensor 12 generates a signal, corresponding to total flow through sensor 12. The signal produced corresponds to the sum of flow produced from the sample gas (analyte) as it flows from combustion system 14 (not pictured), and the carrier gas as it flows from electronic flow control (EFC) module 16. In the preferred embodiment, flow sensor 12 is a Honeywell AWM4300V sensor. As mentioned, combustion system 14 may be any variety of TOC analyzer system as known in the art, as such, characteristics of system 14 are of no great importance (other than the detector).

The analog signal generated by flow sensor 12 is then selected by multiplexer 18. In the preferred embodiment, multiplexer 18 may be of appropriate variety apparent to those skilled in the art, such as a P15A319.

The selected analog signal is then sent to analog to digital converter (ADC) 20. In the preferred embodiment, ADC 20 is an LTC-1864, but appropriate substitutes will be apparent to those skilled in the art. The digital output from ADC 20 is then read by PIC micro-controller 22. In the preferred embodiment, controller 22 is a PIC16F876, or an appropriate substitute as determined by one of skill in the art. The ADC 20 reading is then compared with a computed user-defined set point. This user-defined set point is introduced to the system at user interface 24 and can be continuously adjusted in real time. This feature alone, sets the present invention apart from systems known in the art. Specifically, this real time, continuously adjustable, set point allows the user to utilize multiple calibration curves, each of which is based on the total flow being directed through the NDIR sensor. This enables the user to adapt to different analyte matrices and concentration ranges to optimize system performance by utilizing different system methods or configurations.

PIC micro-controller 22 utilizes a PID algorithm to generate an output waveform. Said output waveform is sent, as output, to VSO valve 26. VSO valve 26 is thereby controlled by the waveform, produced by the PID algorithm, and received from PIC micro-controller 22. In the preferred embodiment valve 26 is a standard control valve, such as a Pneutronics VSO NC-1s11-VD-FOU. Ultimately, actuation of VSO valve 26 determines how much carrier gas flows through the EFC module 16.

In the preferred embodiment, Frit 28 is fitted to the output of VSO valve 26 as part of the EFC module 16 and is primarily responsible for additional restriction downstream from VSO valve 26. VSO valves 26 generally have fixed orifice sizes (e.g. 0.010″, 0.020″, 0.030″, 0.050″, or 0.065″) which permit extremely large flow rates, typically ranging from 2 to 25 liters per minute (at standard temperature and pressure). The placing the frit 28 downstream of a VSO valve 26 has several advantages: (1) isolation of the “pulse” nature of VSO valve 26 output from flow/ pressure sensor 12, (2) compression of the “useful range” for better control in the flow region of interest, and (3) isolates the flow/pressure sensor 12 from upstream flow or pressure upsets. Taken together, frit 28 increases ease of use, improves the flow precision (greatly reduces flow oscillations about the set point), and eliminates problems with potential ‘blockages’ due to particulates being entrained and being ‘stuck’ in a standard orifice. Alternatively, use of frits 28, or screens upstream of the VSO valve 26 orifice for the express purpose of eliminating particulates, would permit the use of a suitably sized orifice (e.g. 0.002″, 0.005″, etc.) in place of a frit. The major advantage of frit 28 however, remains the ease of installation, and ability to withstand significant accumulation of particulates before its performance would suffer due to the multiplicity of paths through the frit versus the single flow path through an orifice. Finally, frit 28 is fitted to the output of EFC module 16 and can be used for throttling the flow through VSO valve 26, greatly reducing the maximum flow that would otherwise be possible, and increasing the degree of flow regulation and control. The use of a frit 28 together with the VSO valve 26 and PID control significantly reduces the amplitudes of the flow pulses, and thus ensures more stable and reproducible flow.

Particular embodiments of the present invention provides for an adjustable frit 28, standing alone or in combination, whereby the given resistance (or back-pressure) of the system can be manipulated according to system or operator needs.

Summarily, in the preferred embodiment, the signal from mass flow sensor 12 is digitized and the digitized response is compared with the desired total mass flow rate (as defined within user interface 24). Digital proportional, integral, and differential control (PID) is programmed into micro-controller 22 to control electronic circuitry to operate proportional valve 26 as required for the regulation of flow. The benefit of using digital control is that the PID coefficients can be optimized in code (please see attached code), and does not require replacement of resistors and/or capacitors as is required with traditional analog PID control circuitry.

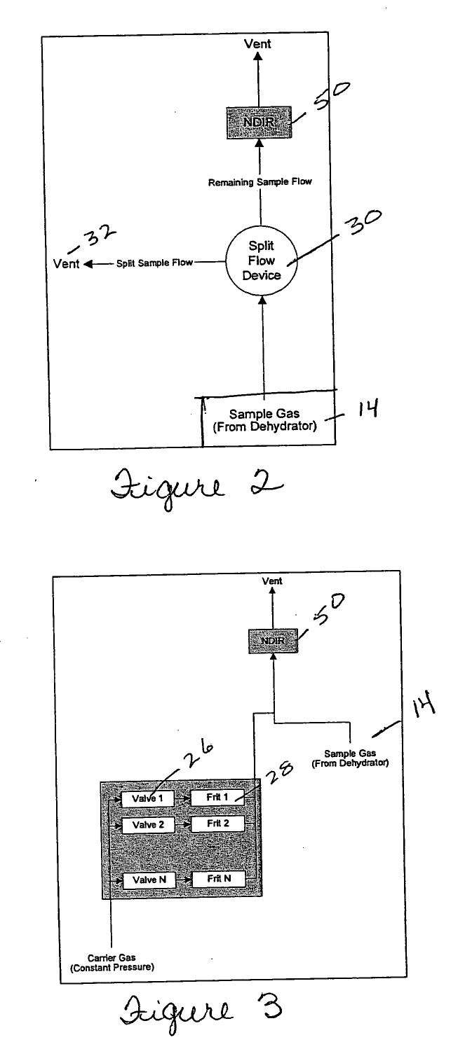

Referring to FIG. 2, an alternative embodiment of the present system is presented. In this embodiment, split flow device 30 receives sample gas from combustion system 14 (not pictured). Split flow device 30 effectively splits the flow and directs resulting flow to vent 32 and detector 50.

Referring to FIG. 3, an alternative embodiment of the present system is presented. In this embodiment, a plurality of valves 26 and frits 28 are housed in a modular frame. This configuration is thought to be particularly useful in allowing a system operator and great range of dynamic flexibility.

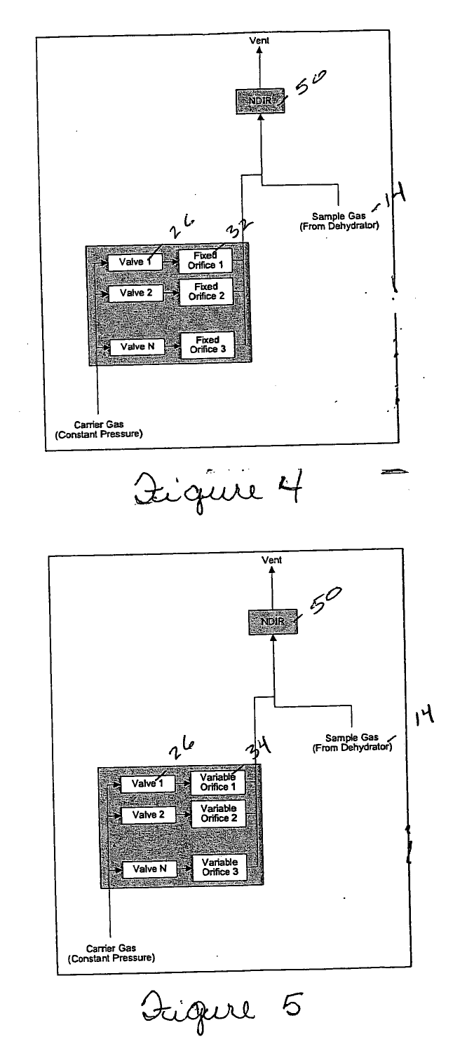

Referring to FIG. 4, an alternative embodiment of the present system is presented. In this embodiment, a plurality of valves 26 and fixed orifices 32 are housed in a modular frame. Again, this configuration is thought to be particularly useful in allowing a system operator and great range of dynamic flexibility.

Referring to FIG. 5, an alternative embodiment of the present system is presented. In this embodiment, a plurality of valves 26 and variable orifices 34 are housed in a modular frame. Again, this configuration is thought to be particularly useful in allowing a system operator and great range of dynamic flexibility.

Although the invention has been described with reference to specific embodiments, this description is not meant to be construed in a limited sense. Various modifications of the disclosed embodiments, as well as alternative embodiments of the inventions will become apparent to persons skilled in the art upon reference to the description of the invention. It is, therefore, contemplated that the appended claims will cover such modifications that fall within the scope of the invention.

I claim:

1. An electronically controlled gas flow system, comprising:
a flow sensor configured to measure fluid flow and produce an analog flow signal corresponding to said flow;
a multiplexer configured for receiving said analog flow signal produced by said flow sensor, and transmitting said analog flow signal to an analog to digital converter;
an analog to digital converter configured for receiving said analog flow signal and converting it to a digital flow signal;
a controller configured to receive said digital flow signal from said analog to digital converter, apply user-defined processing parameters to said digital flow signal and produce a control signal for transmission to a control valve,
said user interface configured for receiving user-defined parameters for acceptable flow through said flow sensor and transmitting said parameters to said controller, for processing with said digital flow signal;
a control valve configured to receive said control signal from said controller and actuate between an open and closed position to control flow to said sensor, according to said control signal;
a detector mechanism configured to receive fluid flow from said sensor, and produce a corresponding detection signal therein.

2. An electronically controlled gas flow system, comprising:
a flow sensing means for sensing fluid flow and producing an analog signal corresponding to said flow,
a selecting means for selecting said analog flow signal produced by said sensing means, and transmitting said analog flow signal to a converting means,
a converting means for receiving said analog flow signal and converting it to a digital flow signal,
a processing means configured to receive said digital flow signal from said converting means, apply user-defined processing parameters to said digital flow signal and produce a control signal for transmission to a valve means,
user interface means configured for receiving user-defined parameters for acceptable flow through said flow sensor and transmitting said parameters to said control means, for processing with said digital flow signal,
a valve means configured to receive said control signal from said controller and actuate between an open and closed position to control flow to said sensing means, according to said control signal,
a detector means configured to receive fluid flow from said sensing means, and produce a corresponding detection signal therein.

3. An improved oxidative system, comprising:
a transfer mechanism configured to provide effective transfer of a sample fluid to a reaction chamber,
said reaction chamber where said sample fluid is reacted with one or more catalytic materials,
flow mechanism whereby said sample fluid is swept by a gas from said reaction chamber,
a drying mechanism where said sample fluid is received from said reaction chamber, through said flow mechanism, and is deprived of excess moisture,
a dehydration mechanism where said sample fluid is received from said drying mechanism, through said flow mechanism, and is further deprived of excess moisture,
An electronically controlled gas flow system, comprising:
a flow sensor configured to measure fluid flow and produce an analog flow signal corresponding to said flow;
a multiplexer configured for receiving said analog flow signal produced by said flow sensor, and transmitting said analog flow signal to an analog to digital converter;
an analog to digital converter configured for receiving said analog flow signal and converting it to a digital flow signal;
a controller configured to receive said digital flow signal from said analog to digital converter, apply user-defined processing parameters to said digital flow signal and produce a control signal for transmission to a control valve,
said user interface configured for receiving user-defined parameters for acceptable flow through said flow sensor and transmitting said parameters to said controller, for processing with said digital flow signal;
a control valve configured to receive said control signal from said controller and actuate between an open and closed position to control flow to said sensor, according to said control signal;
a detector mechanism configured to receive fluid flow from said sensor, and produce a corresponding detection signal therein

4. An improved oxidative system, comprising:
a transfer means whereby said fluid is transferred to a reaction chamber means,
said reaction chamber means whereby a sample fluid is reacted with one or more catalytic materials,
a flow mechanism means whereby said sample fluid is swept by a gas from said reaction chamber means,
a drying means where said sample fluid is received from said reaction chamber means, through said flow mechanism means, and is deprived of excess moisture,
a dehydration means where said sample fluid is received from said drying means, through said flow mechanism means, and is further deprived of excess moisture,
An electronically controlled gas flow system, comprising:
a flow sensing means for sensing fluid flow and producing an analog signal corresponding to said flow,
a selecting means for selecting said analog flow signal produced by said sensing means, and transmitting said analog flow signal to a converting means,
a converting means for receiving said analog flow signal and converting it to a digital flow signal,
a processing means configured to receive said digital flow signal from said converting means, apply user-defined processing parameters to said digital flow signal and produce a control signal for transmission to a valve means,
user interface means configured for receiving user-defined parameters for acceptable flow through said flow sensor and transmitting said parameters to said control means, for processing with said digital flow signal,
a valve means configured to receive said control signal from said controller and actuate between an open and closed position to control flow to said sensing means, according to said control signal,
a detector means configured to receive fluid flow from said sensing means, and produce a corresponding detection signal therein.

5. The electronically controlled gas flow system of claim 1, further comprising:
a split flow device wherein said split flow device effectively separates fluid flow received, thereby directing a only a portion of received fluid flow to said detector mechanism.

6. The electronically controlled gas flow system of claim 1, further comprising:
a purging means, wherein said purging means is configured to produce a high fluid flow through said detection mechanism before and after a sample fluid has been swept through said detector mechanism.

7. An electronically controlled gas flow system for use within a total organic carbon analyzer, comprising:
a flow sensor configured to measure fluid flow and produce an analog flow signal corresponding to said flow;
a multiplexer configured for receiving said analog flow signal produced by said flow sensor, and transmitting said analog flow signal to an analog to digital converter;
an analog to digital converter configured for receiving said analog flow signal and converting it to a digital flow signal;
a controller configured to receive said digital flow signal from said analog to digital converter, apply user-defined processing parameters to said digital flow signal and produce a control signal for transmission to a control valve,
said user interface configured for receiving user-defined parameters for acceptable flow through said flow sensor and transmitting said parameters to said controller, for processing with said digital flow signal;
a control valve configured to receive said control signal from said controller and actuate between an open and closed position to control flow to said sensor, according to said control signal;
a detector mechanism configured to receive fluid flow from said sensor, and produce a corresponding detection signal therein.

8. An electronically controlled gas flow system for use within a total organic carbon analyzer, comprising:
a flow sensing means for sensing fluid flow and producing an analog signal corresponding to said flow,
a selecting means for selecting said analog flow signal produced by said sensing means, and transmitting said analog flow signal to a converting means,
a converting means for receiving said analog flow signal and converting it to a digital flow signal,
a processing means configured to receive said digital flow signal from said converting means, apply user-defined processing parameters to said digital flow signal and produce a control signal for transmission to a valve means,
user interface means configured for receiving user-defined parameters for acceptable flow through said flow sensor and transmitting said parameters to said control means, for processing with said digital flow signal,
a valve means configured to receive said control signal from said controller and actuate between an open and closed position to control flow to said sensing means, according to said control signal,
a detector means configured to receive fluid flow from said sensing means, and produce a corresponding detection signal therein.

9. An improved oxidative system for use within a total organic carbon analyzer, comprising:
a transfer mechanism configured to provide effective transfer of a sample fluid to a reaction chamber,
said reaction chamber where said sample fluid is reacted with one or more catalytic materials,
flow mechanism whereby said sample fluid is swept by a gas from said reaction chamber,
a drying mechanism where said sample fluid is received from said reaction chamber, through said flow mechanism, and is deprived of excess moisture,
a dehydration mechanism where said sample fluid is received from said drying mechanism, through said flow mechanism, and is further deprived of excess moisture,
an electronically controlled gas flow system, comprising:
a flow sensor configured to measure fluid flow and produce an analog flow signal corresponding to said flow;
a multiplexer configured for receiving said analog flow signal produced by said flow sensor, and transmitting said analog flow signal to an analog to digital converter;
an analog to digital converter configured for receiving said analog flow signal and converting it to a digital flow signal;
a controller configured to receive said digital flow signal from said analog to digital converter, apply user-defined processing parameters to said digital flow signal and produce a control signal for transmission to a control valve,
said user interface configured for receiving user-defined parameters for acceptable flow through said flow sensor and transmitting said parameters to said controller, for processing with said digital flow signal;
a control valve configured to receive said control signal from said controller and actuate between an open and closed position to control flow to said sensor, according to said control signal;
a detector mechanism configured to receive fluid flow from said sensor, and produce a corresponding detection signal therein.

10. An improved oxidative system for use within a total organic carbon analyzer, comprising:
a transfer means whereby said fluid is transferred to a reaction chamber means,
said reaction chamber means whereby a sample fluid is reacted with one or more catalytic materials,
a flow mechanism means whereby said sample fluid is swept by a gas from said reaction chamber means,
a drying means where said sample fluid is received from said reaction chamber means, through said flow mechanism means, and is deprived of excess moisture,
a dehydration means where said sample fluid is received from said drying means, through said flow mechanism means, and is further deprived of excess moisture,
An electronically controlled gas flow system, comprising:
a flow sensing means for sensing fluid flow and producing an analog signal corresponding to said flow,
a selecting means for selecting said analog flow signal produced by said sensing means, and transmitting said analog flow signal to a converting means,
a converting means for receiving said analog flow signal and converting it to a digital flow signal,
a processing means configured to receive said digital flow signal from said converting means, apply user-defined processing parameters to said digital flow signal and produce a control signal for transmission to a valve means,
user interface means configured for receiving user-defined parameters for acceptable flow through said flow sensor and transmitting said parameters to said control means, for processing with said digital flow signal,
a valve means configured to receive said control signal from said controller and actuate between an open and closed position to control flow to said sensing means, according to said control signal,
a detector means configured to receive fluid flow from said sensing means, and produce a corresponding detection signal therein.

11. The electronically controlled gas flow system of claim 7, further comprising:
a split flow device wherein said split flow device effectively separates fluid flow received, thereby directing a only a portion of received fluid flow to said detector mechanism.

12. The electronically controlled gas flow system of claim 7, further comprising:
a purging means, wherein said purging means is configured to produce a high fluid flow through said detection mechanism before and after a sample fluid has been swept through said detector mechanism.
